(19) United States
(12) Patent Application Publication
(10) Pub. No.: US 2007/0029174 A1
(43) Pub. Date: Feb. 8, 2007

(54) Mechatronic control system

(75) Inventor: Willem Niesing, Ede (NL)

Correspondence Address: DYKEMA GOSSETT PLLC, 39577 WOODWARD AVENUE, SUITE 300, BLOOMFIELD HILLS, MI, 48304-5086, US

(73) Assignee: Eaton Automotive B.V.

(21) Appl. No.: 11/505,517

(22) Filed: Aug. 17, 2006

Related U.S. Application Data
(63) Continuation of application No. PCT/NL05/00127, filed on Feb. 21, 2005.

(30) Foreign Application Priority Data
Feb. 19, 2004 (NL) 1025523

(51) Int. Cl. H01H 13/70

(52) U.S. Cl. 200/1 R

(57) ABSTRACT

A mechatronic system comprising an actuator and an electronic control. The actuator includes two actuator parts arranged to be adjustable relative to each other along an adjustment path by a mechanical drive. The electronic control is coupled with the drive, and includes a position detector for detecting the relative position of the actuating parts in at least one position along the adjustment path. The position detector comprises a semiconductor cooperating with an electric field source. The electric field source is arranged on one actuator part and the semiconductor is arranged on another actuator part, such that a flux of an electric field caused by the electric field source penetrates into the semiconductor in the at least one position along the adjustment path.

### TECHNICAL FIELD

The invention relates to a mechatronic control system.

### SUMMARY AND BACKGROUND

A mechatronic system is provided comprising an actuator and an electronic control. The actuator includes two actuator parts arranged to be adjustable relative to each other along an adjustment path by a mechanical drive. The electronic control is coupled with the drive, and includes a position detector for detecting the relative position of the actuating parts in at least one position along the adjustment path. The position detector comprises a semiconductor cooperating with an electric field source. The electric field source is arranged on one actuator part and the semiconductor is arranged on another actuator part, such that a flux of an electric field caused by the electric field source penetrates into the semiconductor in the at least one position along the adjustment path.

Mechatronic control systems can be used, for instance, to control the position of a vehicle's rearview mirror or wing mirror coupled with the actuator, to control the position of headrests, headlights or valves.

The drive is typically of electric design, for instance one using an electric motor or electromagnet, but can also be made of hydraulic or pneumatic design. The position detector is usually of electromechanical design, for instance designed as an end switch or potentiometer, but can also be made, for instance, of optomechanical design, for instance designed as a photocell or encoder.

Depending on the use of the mechatronic control system, a particular type of drive and a particular type of position detector may be chosen. For uses in the automobile industry, where it is often required that the control system can be mass-produced at low cost price and where, during use, the control system is exposed to vibrations, shocks and temperature changes, there is often a need for a mechatronic control system with a position detector of an alternative type.

An object of the invention is to provide a mechatronic control system in which the position detector is utilized. The mechatronic control system associated with an embodiment of the invention includes a position detector comprising a semiconductor cooperating with an electric field source, wherein the electric field source is arranged on one actuator part and the semiconductor is arranged on the other actuator part, such that a flux of an electric field caused by the electric field source penetrates into the semiconductor in the at least one position along the adjustment path.

For example, during adjustment of the actuator, by influencing the electric conductivity of the semiconductor with the flux of the electric field that is caused by the electric field source, a position signal can be generated with the semiconductor. The position signal can then be binarily compared by the control with a predetermined, fixed value, for instance for realizing an end switch. However, the position signal can also be compared by the control with a settable predetermined value, for instance for realizing a memory function. Furthermore, on the basis of the strength of the position signal, the control can not only switch the drive on or off, but can also control the energization of the drive depending on the strength of the position signal.

In an embodiment, the electric field source comprises an electret, i.e., a dielectric which has been permanently polarized or has been provided with a net electric charge, so that the electret causes a static electric field. Also applicable are other electric field sources, such as, for instance, a capacitor or electrode, or other conducting surface, to be adjusted to an electric tension. By designing the electric field source as an electret, a compact field source may be obtained which does not require electric wiring, since the half-life of the polarization or the net electric charge amounts to a significant number of years, for instance 10 years. The electret can thus function during the whole life of the actuator or a considerable part of that life, without the electret needing to be polarized again or needing to be provided with a net charge again. Since the charge distribution on the electret does not need to be adjusted during the life, the electret can be designed to be free of wiring and/or electric connections. By saving electric wiring, a reduction in complexity of the actuator design and in assembly costs is achieved. Moreover, the electret can be designed with a relatively high voltage, so that a relatively accurate detection can be obtained.

The semiconductor can be designed as a transistor of the MOSFET type. In that case, a conducting channel is formed between two specifically doped areas, namely, a source and a drain, in a substrate with semi-conducting properties. By bringing the electric field source in the proximity of the conducting channel, the number of available free charge carriers in the channel is locally influenced, since the free charge carriers, as a result of the electric field applied, either flow to the surface of the transistor or flow away into the substrate, depending on the kind of free charge carriers and the direction of the electric field induced. As a result, the conducting properties of the conducting channel in the silicon change. By measuring a conduction characteristic of the transistor, in an elegant manner a relation is created with the presence of the electric field, and hence with the position of the electric field source relative to the semiconductor.

By adjusting the actuator parts in a direction which is substantially transverse to the direction of the flux penetrating into the semiconductor, the amount of flux of the electric field that penetrates into the semiconductor is settable, so that the extent of electric conductivity of the semiconductor is a measure for the relative position of the actuator parts. In particular for use of the mechatronic system in a hinge actuator, such as, for instance, an adjustment mechanism of a wing mirror unit or a headlight unit, an angular displacement can be detected. Incidentally, by adjusting the actuator parts in a direction substantially parallel to the direction of the flux penetrating into the semiconductor, a mechatronic system can be obtained which enables adequate detection of a predetermined relative position of the actuator parts, such as, for instance, an end position of a wing mirror housing relative to a base plate on the body of a motor vehicle, or an end position of valves.

An electric field source and a semiconductor can cooperate in pairs. It is also conceivable, however, that an electric field source cooperates with several semiconductors and/or that a semiconductor cooperates with several electric field sources. In this way, a purely quantitative measurement is not necessary. A detection of presence or absence of an electric field source near a semiconductor can be quantified, which renders the measurement less sensitive. Thus, the detection is also less dependent on the so-called threshold voltage of a MOSFET, that is, the minimum voltage that is needed to ensure substantial conduction in the conducting channel, which tends to drift, depending on, for instance, the temperature and the presence of charge, contaminating particles and moisture. In an embodiment, an electric field source is used which is situated along the adjustment path near a relatively large semiconducting surface in which several MOSFETs are arranged, so that an inexpensive and yet accurate position detector is obtained.

Preferably, the actuator is designed as a hinge actuator, so that in an elegant manner the angular position of the actuator parts can be detected. It is also possible to equip the mechatronic control system according to an embodiment of the invention with a linear actuator or an actuator of a different type. Furthermore, it is possible to equip the actuator with a multiple number of actuator parts, for instance three, with a further actuator part possibly being free of semiconductor or electric field source.

The induced electric field in the semiconductor can be generated in a direct manner by the electric field source, for instance via air or a dielectric, or in an indirect manner, for instance by arranging an insulated conductor between the semiconductor and the electric field source. The size and shape of the surfaces of the electric field source and the semiconductor, respectively, can substantially correspond or differ. The overlapping area of the field source and the semiconductor is a measure for the relative position of the two actuator parts.

By using a MOSFET which is manufactured from a polymer with semiconducting properties, a relatively large conducting channel can be obtained, so that the sensitivity of the detection increases.

The invention also relates to a method for operating an actuator, wherein actuator parts are adjusted relative to each other along an adjustment path by means of a drive and wherein, for the purpose of controlling the drive, the relative position of the actuator parts is determined by varying the flux of an electric field generated by an electric field source, that penetrates into the semiconductor.

Further aspects and advantages of the invention are embodied in the claims.

### BRIEF DESCRIPTION OF THE DRAWINGS

Aspects and embodiments of the invention will be further elucidated on the basis of exemplary embodiments represented in the following drawings:

FIG. 1 shows a schematic representation of a mechatronic system, according to an embodiment of the invention, in an initial position;

FIG. 2 shows the mechatronic system of FIG. 1 in an intermediate position;

FIG. 3 shows the mechatronic system of FIG. 1 in an end position; and

FIG. 4 shows a schematic side view of an electric field source and a semiconductor according to an embodiment of the invention.

It is noted that the figures are only schematic representations of embodiments of the invention which is provided in the form of non-limiting exemplary embodiments. In the figures, the same or corresponding parts are designated with the same reference numerals.

### DETAILED DESCRIPTION

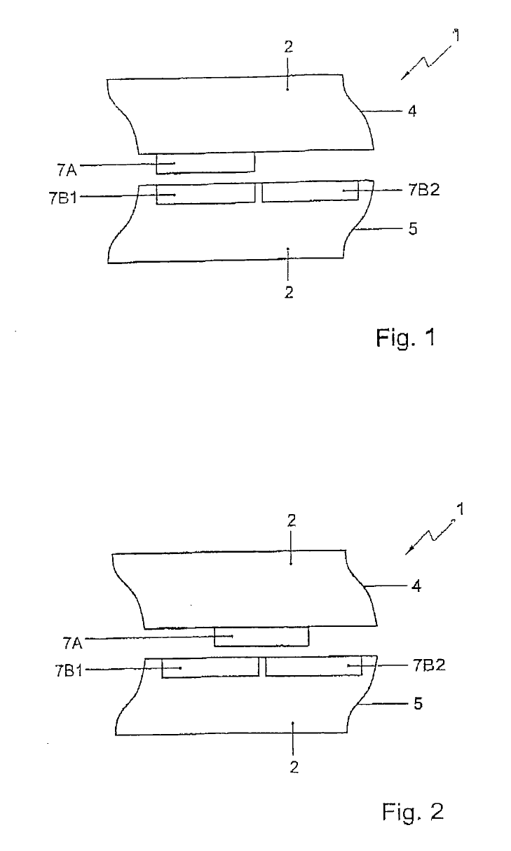

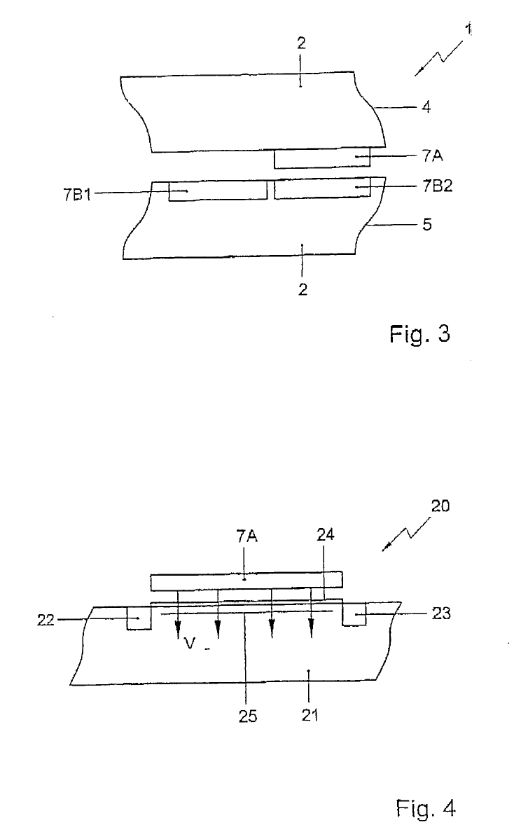

FIG. 1 shows an embodiment of a mechatronic system 1 comprising an actuator 2 with two actuator parts 4,5 arranged so as to be adjustable relative to each other along an adjustment path by means of a mechanical drive, not shown. In this exemplary embodiment, the adjustment path extends from an initial position shown in FIG. 1 via an intermediate position shown in FIG. 2 to an end position shown in FIG. 3.

The system 1 is further provided with an electronic control, not shown, that is coupled with the drive. The control is provided with a position detector 7 for detecting positions of the actuator parts relative to each other.

The position detector 7 comprises a semiconductor 7B cooperating with an electric field source designed as electret 7A. The electret 7A is arranged on one actuator part 4, while semiconductors 7B1, 7B2 are arranged on the other actuator part 5. The electret 7A can comprise a commercially available dielectric that is polarized or provided with net charge. The semiconductors are comprised of silicon or a polymer material having semiconducting properties, and are embedded in the actuator part 5, which can be comprised of plastic.

In a preferred embodiment, the actuator part is manufactured together with the semiconductor in one injection molding process, so that manufacturing costs are reduced. The electret 7A causes an electric field V which is situated along the adjustment path and which, when the semiconductors 7B1, 7B2 on the one hand and the electret 7A on the other are displaced relative to each other along the adjustment path, overlaps in at least one position the surface of the semiconductors 7B1, 7B2 at least partly. By adjustment of the actuator parts 4,5 relative to each other, the extent of overlap can be modified. In particular, the extent of overlap between the electret 7A and a first semiconductor 7B1 is 100% in an initial position shown in FIG. 1. Through adjustment of actuator part 4 along the adjustment path, the overlap gradually decreases to 0%. At the same time, the overlap of the field of the electret 7A and the surface of the semiconductor 7B2 increases gradually from 0% to 100% via an intermediate position shown in FIG. 2 to an end position shown in FIG. 3. The electret and the semiconductor here cooperate in a contactless manner. Along the adjustment path, the actuator parts follow a predetermined path which ensures contactless cooperation. Preferably, the electret and/or semiconductor are made of substantially flat design, so that a large overlapping surface is obtained, which is beneficial to the sensitivity and hence the accuracy of the mechatronic system.

Preferably, the charge distribution over the surface of the electret is provided such that the positive charge is situated substantially on one side of the electret, for instance the side facing the semiconductor, and the negative charge on the other side, so that the effect of the electric flux is utilized as efficiently as possible.

In an embodiment according to the invention, for example, as shown in FIG. 4, the semiconductor is designed as an NMOS transistor 20 of the FET type. Such a transistor 20 is provided with a substrate 21, or bulk material, which comprises a p-type doped silicon structure. Near the surface of the substrate 21, n+-type doped areas are provided for forming a source 22 and a drain 23. On the surface of the transistor 20, a thin insulating layer 24, for instance of a thickness of 10 micrometers or less, is provided. The insulating layer 24 comprises, for instance, silicon oxide or a polymer having insulating properties. Situated between the source 22 and the drain 23 is a conducting channel 25 through which proceeds transport of charge carriers, in this case chiefly electrons. By applying, with the aid of the electret 7A, a flux of an electric field V at the point where in a standard FET type transistor the gate is provided, while the electric field lines V are directed through the conducting channel 25 in the direction of the substrate 21, a thin layer of free electrons is formed at the surface of the conducting channel. These electrons have been drawn from the substrate 21 and increase the electric conductivity of the material in the conducting channel 25. By measuring this conductivity with a measuring signal, for instance by means of a current measurement at an applied voltage between the source 22 and the drain 23, a relation is established with the presence of the electric field V, which in turn is a measure for the position of the electret 7A relative to the NMOS transistor 20.

Depending on the strength of the electric field near the surface of the electret 7A, the influence of the electric field V decreases more or less fast, so that a relatively small change in overlap of the actuator parts can be detected relatively simply. In order to obtain an accurate measurement, corresponding surfaces of the actuator parts have only a small offset relative to each other.

In another embodiment, in which use is made of a PMOS transistor, the operation is similar to that of the NMOS transistor described. The extent of electric conduction in the conducting channel 25 is chiefly determined by the number of free holes, which can be drawn from an n-type substrate by applying an external electric field.

It is noted that the above-described NMOS and PMOS transistor only constitutes the source and the drain, including the intervening semiconductor material that forms an electric conducting channel under the influence of an electric flux, without the gate. The electret fulfills the function of the gate, that is, forming the electric conducting channel by means of an electric flux.

It is further noted that the electric flux penetrates the semiconductor by way of the induced free charge carriers only to a slight extent, because it is virtually compensated in the semiconductor by charge carriers that are drawn to the surface under the influence of the flux. The electric flux is here oriented substantially transversely relative to the surface of the semiconductor.

Through modification of the extent of overlap, the conductivity of the semiconductors 7B1, 7B2 is influenced. By way of example, when the mechatronic system 1 is started by means of a start signal S, an electric motor of the actuator 2 is energized and adjusts the actuator part 4 via a speed reduction mechanism coupled with the output shaft of the electric motor, along the adjustment path relative to the actuator part 5. The actuator parts 4,5 are here adjusted in a direction which is substantially transverse to the direction of the flux penetrating into the semiconductors. As the end position is approached, the extent of overlap between the electret 7A and a second semiconductor 7B2 becomes greater, so that the electric conductivity of the second semiconductor 7B2 increases under the influence of the flux of the electric field of the electret 7A. When the measuring signal of the conductivity in the second semiconductor 7B2 that is fed back to the control reaches a pre-set, fixed value, the current to the electric motor is interrupted. After reversal of the polarity of the motor, adjustment of the actuator in the reverse direction can take place.

In FIGS. 1-3, a linear actuator is represented. However, the actuator can also be designed differently, for instance as an actuator in which the actuator parts pivot relative to each other, for instance for use in a hinge actuator. In such an embodiment, the adjustment path may comprise a curved segment. In that case too, the electric motor of the actuator can be cut off when the measuring signal of the electric conductivity of a semiconductor reaches a predetermined value. Thus, the actuator 2 can be operated in a manner whereby the actuator parts 4,5 are adjusted along an adjustment path by means of a drive and whereby, for the purpose of the control of the drive, the relative position of the actuator parts 4,5 is determined by, during the adjustment of the actuator parts 4,5 relative to each other, varying the electric conductivity of the semiconductor by means of the electric field of the electret.

As appears from FIGS. 1-4, the orientation of the conducting channel from source to drain is substantially transverse to the direction in which the actuator moves. Naturally, it is also possible to design the geometry of the mechatronic system differently, for instance such that the longitudinal direction of the conducting channel substantially coincides with the direction in which the actuator moves.

In addition, through the use of an electric field source which cooperates with several semiconductors and/or a semiconductor which cooperates with several electric field sources, a pattern can be implemented whereby the mechatronic system at a number of positions in a direction transverse to the direction in which the actuator moves, comprises a unique arrangement of overlapping surfaces of semiconductors and/or electric field sources, so that the position of the actuator can be determined through detection of specific position-dependent conduction characteristics, for instance by referring to a position table. The position-dependent conduction characteristic then extends in a direction transverse to the direction in which the actuator moves. Thus, a specific magnitude of overlap of a semiconductor/electric field source combination can form a binary structure. By the use of a multiple number of such binary structures in that direction transverse to the direction in which the actuator moves, many positions of the actuator can be established, for instance by making use of a conversion or position table. When, for instance, six binary structures are used, 64 positions of the actuator can be detected. Naturally, it is also possible to use different numbers of binary structures, e.g. two or eight.

It will be clear that the invention is not limited to the exemplary embodiments represented here. For instance, it is not necessary that adjustment of the actuator parts results in a change in their relative overlap. In another embodiment according to the invention, the actuator parts vary in a direction which is substantially parallel to the direction of the flux penetrating into the semiconductor, so that a predetermined position can be accurately detected, such as for instance an end position of an adjustment path.

The operation of the electric field source and the associated semiconductor can also be used for manufacturing a force sensor by attaching the electric field source or the semiconductor to a spring. By attaching the electric field source or the semiconductor to a mass, an acceleration sensor is obtained.

The mechatronic system can also be designed as a so-called microelectromechanical system (MEMS), so that position detection can also take place elegantly in very small constructions.

Many variations are possible within the scope of the invention as set forth in the following claims.

What is claimed is:

1. A mechatronic system, comprising:
an actuator having at least two actuator parts arranged so as to be adjustable relative to each other along an adjustment path by a mechanical drive; and
an electronic control coupled with the drive, the electronic control including a position detector for detecting in at least one position along the adjustment path the relative position of the actuator parts;
wherein the position detector comprises a semiconductor cooperating with an electric field source, and wherein the electric field source is arranged on one actuator part and the semiconductor is arranged on another actuator part, such that a flux of an electric field caused by the electric field source penetrates into the semiconductor in the at least one position along the adjustment path.

2. The mechatronic system according to claim 1, wherein the electric field source comprises an electret.

3. The mechatronic system according to claim 2, wherein the electret comprises a dielectric that is polarized or provided with net charge.

4. The mechatronic system according to claim 1, wherein the semiconductor comprises a MOSFET-type transistor.

5. The mechatronic system according to claim 4, wherein a conducting channel is formed in a substrate with semi-conducting properties between a source and a drain.

6. The mechatronic system according to claim 5, wherein the longitudinal direction of the conducting channel substantially coincides with the direction in which the actuator moves.

7. The mechatronic system according to claim 1, wherein the semiconductor is configured as a NMOS transistor.

8. The mechatronic system according to claim 7, wherein the NMOS transistor is of the FET type.

9. The mechatronic system according to claim 1, wherein the semiconductor is configured as a PMOS transistor.

10. The mechatronic system according to claim 1, wherein the actuator parts pivot relative to each other.

11. The mechatronic system according to claim 10, wherein the adjustment path includes a curved segment.

12. The mechatronic system according to claim 1, wherein the amount of flux of the electric field that penetrates into the semiconductor is settable through adjustment of the actuator parts relative to each other.

13. The mechatronic system according to claim 12, wherein the adjustment of the actuator parts is in a direction substantially transverse to the direction of the flux penetrating into the semiconductor.

14. The mechatronic system according to claim 1, wherein at least one of the actuator parts includes several semiconductors arranged along the adjustment path.

15. The mechatronic system according to claim 1, wherein at least one of the actuator parts includes several electric field sources arranged along the adjustment path.

16. The mechatronic system according to claim 1, wherein in the semiconductor two electrodes are arranged for measuring the electric conductivity of the semiconductor material between the electrodes.

17. The mechatronic system according to claim 1, wherein the semiconductor is substantially sheet-shaped.

18. The mechatronic system according to claim 1, wherein the semiconductor is comprised of a polymer.

19. The mechatronic system according to claim 1, wherein the semiconductor is integrated with the actuator part during formation.

20. The mechatronic system according to claim 19, wherein the semiconductor is integrated with the actuator part during an injection molding process.

21. The mechatronic system according to claim 1, wherein the electric field source or the semiconductor are attached to a mass.

22. The mechatronic system according to claim 21, wherein the electric field source or the semiconductor are attached to a spring.

23. A method for operating an actuator, including:
providing an actuator with actuator parts that are arranged to be adjustable relative to each other along an adjustment path;
determining the relative position of the actuator parts by varying, by mutual relative adjustment of the actuator parts, the flux of an electric field caused by an electric field source that penetrates into a semiconductor; and
adjusting the actuator parts relative to each other along an adjustment path using a drive.
